(19) United States
(12) Patent Application Publication
(10) Pub. No.: US 2021/0019625 A1
(43) Pub. Date: Jan. 21, 2021

(54) ELECTRONIC DEVICE AND CONTROL METHOD THEREOF

(71) Applicant: SAMSUNG ELECTRONICS CO., LTD., Gyeonggi-do (KR)

(72) Inventors: Dongsoo LEE, Gyeonggi-do (KR); Byeoungwook LIM, Gyeonggi-do (KR); Kwanghoon SON, Gyeonggi-do (KR); Jonghun LEE, Gyeonggi-do (KR)

(21) Appl. No.: 17/044,104

(22) PCT Filed: Jan. 4, 2019
(86) PCT No.: PCT/KR2019/000142

§ 371 Date: Sep. 30, 2020

(30) Foreign Application Priority Data
May 9, 2018 (KR) 10-2018-0053185

(51) Int. Cl. G06N 3/08; G06F 17/11

(52) U.S. Cl. CPC G06N 3/08; G06F 17/11

(57) ABSTRACT

Disclosed is an electronic device. The present electronic device includes: a memory; and a processor which quantizes a neural network, trained on the basis of deep learning, to generate a quantized neural network, and stores the quantized neural network in the memory, wherein the processor quantizes, in preset first bit units, trained connection strengths between neurons of the trained neural network, inverse-quantizes the quantized connection strengths in preset second bit units, retrains the inverse-quantized connection strengths, and quantizes the retrained connection strengths in the preset first bit units.

### TECHNICAL FIELD

This disclosure relates to an electronic apparatus and a controlling method thereof and, more particularly to, an electronic apparatus which operates based on artificial intelligence (AI) technology and a controlling method thereof.

### BACKGROUND ART

Recently, an AI system that implements human-level intelligence has been developed. The artificial intelligence system is a system that the machine learns and determines by itself, unlike the existing rule-based smart system, and is used in various fields such as speech recognition, image recognition and future prediction.

In recent years, AI systems have been developed that solve a given problem through a deep neural network based on deep learning.

A deeper neural network is a neural network that includes multiple hidden layers between the input and output layers. It is a model that implements artificial intelligence technology through neurons contained in each layer.

It is general that the deep neural network includes a plurality of neurons in order to deduce an accurate result value.

However, when there is a large amount of neurons, accuracy of the output value with respect to the input value is increased, but there is a problem that the time for deriving the output value is delayed.

Also, due to the vast amount of neurons, deep neural networks cannot be used due to a capacity problem in mobile devices such as smart phones with limited memory.

### DISCLOSURE

### Technical Problem

The disclosure has been made to solve the above-described problems, and an object of the disclosure is to provide an electronic apparatus capable of accurately deriving an output value for an input value within a short time by lightening an artificial intelligence model without performance degradation, and realizing artificial intelligence technology even in a mobile device having limited memory.

### Technical Solution

An electronic apparatus according to an embodiment includes a memory and a processor configured to quantize a neural network, trained on based on deep learning, to generate a quantized neural network, and store the quantized neural network in the memory, and the processor may quantize, in a preset first bit unit, trained connection strengths between neurons of the trained neural network, dequantize the quantized connection strengths in a preset second bit unit, retrain the dequantized connection strengths, and quantize the retrained connection strengths in the preset first bit units.

The processor may iteratively perform after the quantization dequantization, retraining, and quantization in preset time units.

The processor may calculate an accuracy of the trained connection strength, calculate an accuracy of quantizing the retrained connection strength in the preset first bit units, and based on the accuracy of quantization being within a preset range from the accuracy of the trained connection strength, stop the iterative operation.

The processor may calculate an accuracy of the trained connection strength, and in performing the retraining, perform the retraining until the accuracy of the retrained connection strength belongs to a preset range from the accuracy of the trained connection strength.

The preset first bit unit may be one bit, and the preset second bit unit may be 32 bits.

The processor may perform the quantization using Equation 1 below and perform the dequantization using Equation 2 below.

$${min}_{{\{ {a}_{i} , {b}_{i} \}}_{i = 1}^{k}} {‖ w - {\sum }_{i = 1}^{k} {a}_{i} {b}_{i} ‖}^{2} \qquad [ Equation 1 ]$$

(w=connection strength, a=optimal coefficient, b=(−1 or +1), k>1

$${\sum }_{i = 1}^{k} {a}_{i} {b}_{i} \qquad [ Equation 2 ]$$

(a=optimal coefficient, b=(−1 or +1))

The electronic apparatus may further include a communicator, and the processor may control the communicator to transmit, to an external device, a neural network in which the retrained connection strength is quantized in the preset first bit unit.

According to an embodiment, a method for controlling an electronic apparatus for quantizing a neural network, trained on a basis of deep learning, to generate a quantized neural network, and store the quantized neural network includes quantizing, in a preset first bit unit, trained connection strengths between neurons of the trained neural network; dequantizing the quantized connection strengths in a preset second bit unit; retraining the dequantized connection strengths; and quantizing the retrained connection strengths in the preset first bit units.

The method may further include after the quantization, dequantization, retraining, and quantization may be iteratively performed in preset time units.

The method may further include calculating an accuracy of the trained connection strength; and calculating an accuracy of quantizing the retrained connection strength in the preset first bit units, and the iteratively performing may include, based on the accuracy of quantization being within a preset range from the accuracy of the trained connection strength, stopping the iterative operation.

The method may further include calculating an accuracy of the trained connection strength, and the performing the retraining may include performing the retraining until the accuracy of the retrained connection strength belongs to a preset range from the accuracy of the trained connection strength.

The preset first bit unit may be one bit, and the preset second bit unit may be 32 bits.

The quantizing may be performed using Equation 1 below and the dequantizing may be performed using Equation 2 below:

$${min}_{{\{ {a}_{i} , {b}_{i} \}}_{i = 1}^{k}} {‖ w - {\sum }_{i = 1}^{k} {a}_{i} {b}_{i} ‖}^{2} \qquad [ Equation 1 ]$$

(w=connection strength, a=optimal coefficient, b=(−1 or +1), k>1

$${\sum }_{i = 1}^{k} {a}_{i} {b}_{i} \qquad [ Equation 2 ]$$

(a=optimal coefficient, b=(−1 or +1))

The method may further include transmitting, to an external device, a neural network in which the retrained connection strength is quantized in the preset first bit unit.

### Effect of Invention

According to various embodiments as described above, by lightening an artificial intelligence (AI) model without performance degradation, an output value for an input value may be accurately derived within a short time, and artificial intelligence technology may be realized even in a mobile device having limited memory, or the like.

### DESCRIPTION OF DRAWINGS

FIG. 1 is a block diagram illustrating an electronic apparatus according to an embodiment;

FIG. 2 is a diagram illustrating a method of quantizing trained connection strengths by an electronic apparatus according to an embodiment;

FIG. 3 is a diagram illustrating an embodiment of iterative quantization operation by an electronic apparatus according to an embodiment;

FIGS. 4 and 5 are tables showing that an accuracy of connection strength increases by iterative quantization operation by an electronic apparatus according to an embodiment; and

FIG. 6 is a flowchart illustrating a method for controlling of an electronic apparatus according to an embodiment.

### BEST MODE FOR CARRYING OUT THE INVENTION

-

### Detailed Description of Embodiments

The terms used in the present specification and the claims are general terms identified in consideration of the functions of the various embodiments of the disclosure. However, these terms may vary depending on intention, legal or technical interpretation, emergence of new technologies, and the like of those skilled in the related art. Also, there may be some terms arbitrarily identified by an applicant. Unless there is a specific definition of a term, the term may be construed based on the overall contents and technological common sense of those skilled in the related art.

A detailed description of conventional techniques related to the disclosure that may unnecessarily obscure the gist of the disclosure will be shortened or omitted.

Embodiments of the disclosure will be described in detail with reference to the accompanying drawings, but the disclosure is not limited to embodiments described herein.

Hereinbelow, the disclosure will be described in greater detail with reference to the drawings attached hereto.

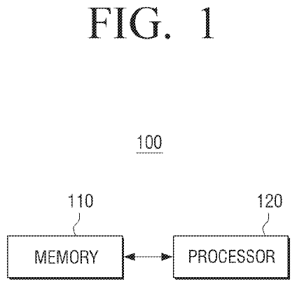

FIG. 1 is a block diagram illustrating an electronic apparatus according to an embodiment. As illustrated in FIG. 1, an electronic apparatus 100 includes a memory 110 and a processor 120.

The electronic apparatus 100 may be an apparatus that obtains output data for input data based on an artificial intelligence model. For example, the electronic apparatus 100 may be a desktop PC, a notebook, a smart phone, a tablet PC, a server, and the like. Alternatively, the electronic apparatus 100 may be the system itself in which the cloud computing environment is built. However, the disclosure is not limited thereto, and the electronic apparatus 100 may be any apparatus as long as the apparatus can be operated using an artificial intelligence model.

The memory 110 is provided separately from the processor 120 and can be implemented as a hard disk, non-volatile memory, volatile memory, or the like.

The memory 110 may store an artificial intelligence model. Here, the artificial intelligence model can be trained through artificial intelligence algorithms. For example, the AI model may be a deep neural network model.

Specifically, the artificial intelligence model may be a Recurrent Neural Network (RNN) trained model. Here, RNN means a cyclic neural network, and is a type of deep learning model for learning data that changes with time, such as time series data.

However, the present disclosure is not limited thereto, and the artificial intelligence model may be a Convolutional Neural Network (CNN) trained model. Alternatively, the memory 110 may store a model generated based on a rule rather than a model trained through an artificial intelligence algorithm, and there is no particular limitation on the model stored in the memory 110.

Deep neural network may include a plurality of layers and each of the layers may include a plurality of neurons.

To be specific, deep neural network may include a plurality of hidden layers between the input layer and the output layer.

Neurons of neighboring layers may be connected by synapses. According to training, connection strength, that is weight, can be assigned to synapses.

The processor 120 generally controls the operation of electronic apparatus 100. To that end, the processor 120 may include one or more of a central processing unit (CPU), an application processor (AP) or a communication processor (CP).

The processor 120 may lighten neural network which is trained based on deep learning.

In general, deep neural network includes a plurality of neurons to derive an accurate result value.

However, when a large amount of neurons is present, the accuracy of the output value with respect to the input value increases, but the time for deriving the output value is delayed, causing a problem.

Also, due to the large amount of neurons, there is a problem that the deep neural network cannot be used due to a capacity problem in a mobile device such as a smart phone having a limited memory.

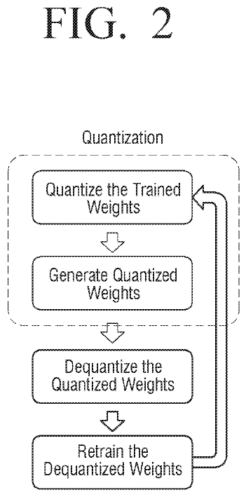

To solve such a problem, the processor 120 can lighten the trained neural network based on the deep learning. Hereinafter, description will be made with reference to FIG. 2.

FIG. 2 is a diagram illustrating a method of quantizing trained connection strengths by an electronic apparatus according to an embodiment.

The processor 120 may lighten the neural network by quantizing the trained connection strength between the neurons of the neural network. Specifically, the processor 120 may lighten the neural network by quantizing the trained connection strength between neurons of the trained neural network in a preset first bit unit.

Here, the trained connection strength is 32 bits, and the preset first bit can be a bit of a smaller unit. For example, the preset first bit may be one bit.

The quantization can be performed through the Greedy approximation technique. Specifically, the processor 120 may quantize the trained connection strength by using a preset first bit unit using Equation 1 Hereinafter, for the sake of convenience of description, it is assumed that the preset first bit unit is one (1) bit.

$${min}_{{\{ {a}_{i} , {b}_{i} \}}_{i = 1}^{k}} {‖ w - {\sum }_{i = 1}^{k} {a}_{i} {b}_{i} ‖}^{2} \qquad [ Equation 1 ]$$

Here, w indicates connection strength, a indicates optimal coefficient, b is −1 or +1, and k may be integer greater than 1.

If

$$w - {\sum }_{j = 1}^{i - 1} {a}_{j} {b}_{j}$$

of Equation 1 is substituted with rᵢ₋₁, a and b of Equation 1 can be expressed as the equation shown below.

$${a}_{i} = \frac{1}{n} {‖ {r}_{i - 1} ‖}_{1} and {b}_{i} = sign ( {r}_{i - 1} ) .$$

For example, if the trained connection strength is represented by a matrix such as [1.1, −0.9, 0.7, −0.5], the processor 120 may calculate that a is 0.8 by using the Equation of (1.1 +0.9 +0.7 +0.5)/4.

The processor 120 can quantize the trained connection strengths [1.1, −0.9, 0.7, −0.5] as [0.8]*[1, −1, 1, −1].

The processor 120 may quantize [0.8]*[1, −1, 1, −1] quantized through the residue method to obtain quantized connection strength with a high degree of matching with the trained connection strength, and express the quantized matrix by adding the matrix to existing [0.8]*[1, −1, 1, −1] using the residue method.

That is, given that a is 0.8, the processor 120 may calculate that a is 0.2 through the equation (0.3 +0.1 +0.1 +0.3)/4 by applying the residue method to the connection strengths [1.1, −0.9, 0.7, −0.5].

The processor 120 may express the trained connection strengths [1.1, −0.9, 0.7, −0.5] to [0.8]*[1, −1, 1, −1]+[0.2]*[1, −1, −1, 1] by quantizing.

Through the iterative quantization operation, the processor 120 can express the trained connection strength as a quantized connection strength.

As such, by quantizing the trained connection strength, the electronic apparatus 100 according to one embodiment can lighten the weight of the neural network.

Meanwhile, an embodiment of quantization using the Greedy approximation technique is described herein, but there is no particular limitation on a method of quantizing the trained connection strength. For example, the quantization may be performed in various ways, such as unitary quantization, adaptive quantization, uniform quantization, or supervised iterative quantization.

The processor 120 may dequantize the connection strength quantized in the preset first bit unit in a preset second bit unit. Here, the preset second bit unit may be the same unit as the bit unit of the connection strength before being quantized. That is, when the connection strengths [1.1, −0.9, 0.7, −0.5] trained in the above embodiment are 32 bits, the dequantized connection strength can also be 32 bits.

In the meantime, dequantization can be performed using Equation 2 as shown below.

$${\sum }_{i = 1}^{k} {a}_{i} {b}_{i} \qquad [ Equation 2 ]$$

Here, a is an optimal coefficient, b is −1 or +1, and k may be an integer which is greater than 1.

For example, as in the above embodiment, if the trained connection strengths [1.1, −0.9, 0.7, −0.5] are quantized as [0.8]*[1, −1, 1, −1]+[0.2]*[1, −1, −1, 1], the processor 120 can dequantize the quantized connection strength to [1.0, −1.0, 0.6, −0.6].

The processor 120 may retrain the dequantized connection strength, and quantize the retrained connection strength using Equation 1 described above.

Here, the method of quantizing the retrained connection strength is the same as the method of quantizing the trained connection strength described above, so a detailed description thereof will be omitted.

Thus, by retraining the dequantized connection strength and re-quantizing the retrained connection strength, the processor 120 can acquire a quantized connection strength having a high degree of matching with the existing connection strength.

That is, the electronic apparatus 100 according to an embodiment not only quantizes the trained connection strength, but also dequantizes the quantized connection strength, retrains the de-quantized connection strength, and re-qunantizes the retrained connection strength, to obtain connection strength with high degree of matching with the existing connection strength and lighten the weight of the neural network at the same time.

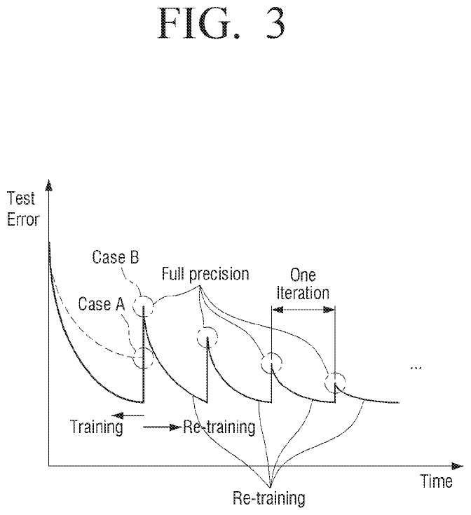

FIG. 3 is a diagram illustrating an embodiment of iterative quantization operation by an electronic apparatus according to an embodiment.

Referring to FIG. 3, as for a related-art electronic apparatus, connection strength is quantized by a method of case A or case B to lighten the neural network.

The case A is a method of performing quantization of the connection strength in the learning process, and, if quantization is performed using this method, as illustrated in FIG. 3, there is an advantage to lower a test error rate to a certain degree compared to case B. Here, the test error rate may be a difference between the connection strength obtained by training and the quantized connection strength.

By the case A, however, the training process is very complicated and time for training is excessively lengthened.

The case B is a method of performing quantization of connection strength after finishing the training process and when the quantization is performed by this method, there is a problem that the test error rate increases.

To solve the above-described problems, the processor 120 may iteratively perform dequantization, retraining, and new quantization after quantization iteratively in preset time units.

Referring to FIG. 3, after the first training process is finished, the processor 120 may quantize the connection strength, dequantize the same to full precision, and retrain the dequantized connection strength.

If the first trained connection strength is 32 bits, full precision may be composed of 32 bits as well.

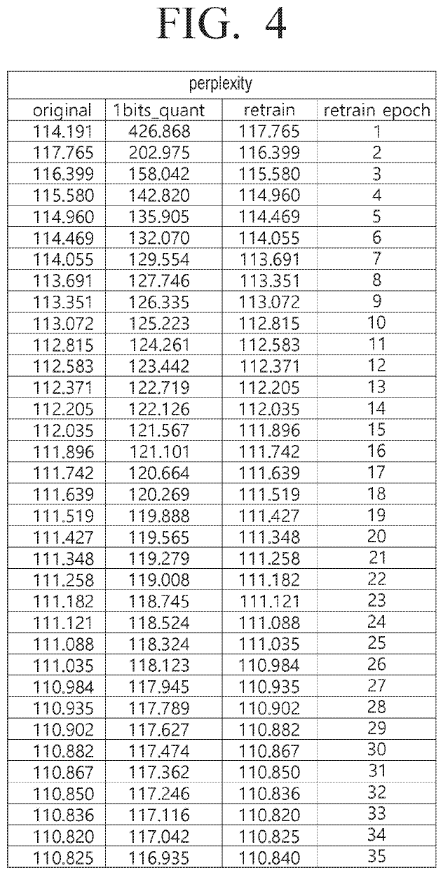

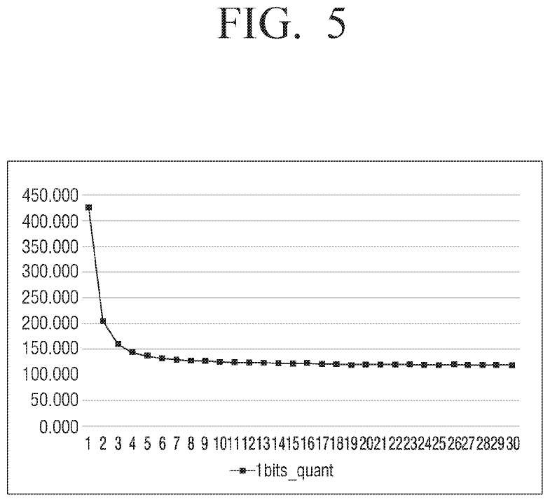

As illustrated in FIG. 3, by iterating the dequantization after quantization, the retraining, and the new quantization process in a preset time unit, the test error rate may be continuously decreased. The specific numeral values are described below with reference to FIGS. 4 and 5.

If the accuracy when the connection strength is quantized after retraining is within a preset range from the accuracy of the first trained connection strength, the iterative operation as described above may be stopped.

The processor 120 may calculate the accuracy of the first trained connection strength, that is, the test error as described above.

The processor 120 may iteratively perform dequantization, retraining, and quantization, and may calculate an accuracy when the retrained connection strength is quantized in a preset first bit unit.

The preset range may be set to 3%, but the numeral value is not limited to a specific range.

The processor 120 may perform the retraining with an epoch in which the accuracy of the retrained connection strength falls within a preset range from the accuracy of the trained connection strength.

The processor 120 may calculate the accuracy of the trained connection strength and the accuracy of the retrained connection strength.

FIGS. 4 and 5 are tables showing that an accuracy of connection strength increases by iterative quantization operation by an electronic apparatus according to an embodiment.

Referring to FIG. 4, original denotes an error rate of a trained connection strength, retrain denotes an error rate of a retrained connection strength, lbit_quant denotes an error rate of a connection strength quantized to 1 bit, and a retrain epoch denotes that dequantization, retraining, and a quantization is considered to be one interval.

Referring to FIG. 4, when the error rate of the trained connection strength is 114.191, the error rate is 426.868 when quantized, and the error rate of the retrained connection strength is 117.765.

When quantized again, the error rate is 202.975 and the error rate of the retrained connection strength is 116.399.

After iteration, in the 35^{th} epoch, the error rate is 116.935, and the error rate of the retrained connection strength is 110.840.

That is, when the dequantization after quantization, the retraining, and the quantization are viewed as one epoch, if iteration if performed, the error rate of quantization is gradually decreased, so that a connection strength with high accuracy may be obtained.

Referring to the graph of FIG. 5, this would be more clear.

In the graph of FIG. 5, when the dequantization after quantization, the retraining, and the quantization are viewed as one epoch, the x-axis denotes the number of times that iteration is performed, and the y-axis denotes the error rate of the quantized connection strength.

As illustrated in FIG. 5, when compared to the accuracy at the first quantization of the connection strength, the error rate of the connection strength is gradually decreased when performing iteration of dequantization after quantization, retraining, and quantization.

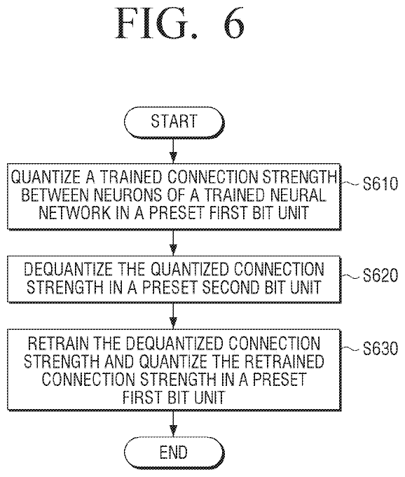

FIG. 6 is a flowchart illustrating a method for controlling of an electronic apparatus according to an embodiment.

According to an embodiment, the electronic apparatus may quantize a trained connection strength between neurons of a trained neural network in a preset first bit unit in operation S610.

As described above, quantization may be performed using Greedy approximation, but is not limited thereto.

The electronic apparatus may dequantize the quantized connection strength in preset second bit units in operation S620.

The electronic apparatus may retrain the dequantized connection strength in operation and may quantize the retrained connection strength in a preset first bit unit in operation S630.

The electronic apparatus may iterate the dequantization after quantization, the retraining, and the quantization described above in a preset time unit.

The electronic apparatus may store the deep neural network quantized in preset first bit units in the memory.

As such, by quantizing the connection strength, the present electronic apparatus may lighten the deep neural network. Accordingly, a problem that the time for deriving the output value is delayed can be overcome, and an artificial intelligence model can be used in a mobile device such as a smart phone or the like.

As the electronic apparatus dequantizes the quantized connection strength, retrains the dequantized connection strength, and then quantizes the connection strength again, the finally quantized connection strength is at a high degree to match the initial connection strength. Accordingly, the artificial intelligence model can be lightened, thereby not causing performance degradation.

A non-transitory computer readable medium which stores a program for sequentially executing a method for controlling an electronic apparatus according to an embodiment may be provided.

The non-transitory computer readable medium refers to a medium that stores data semi-permanently, and is readable by an apparatus. Specifically, the above-described various applications or programs may be stored in the non-transitory computer readable medium such as a compact disc (CD), a digital versatile disk (DVD), a hard disk, a Blu-ray disk, a universal serial bus (USB), a memory card, a ROM or etc., and may be provided.

The foregoing example embodiments and advantages are merely examples and are not to be construed as limiting. The present teaching can be readily applied to other types of apparatuses. Also, the description of the example embodiments is intended to be illustrative, and not to limit the scope of the claims, and many alternatives, modifications, and variations will be apparent to those skilled in the art.

### INDUSTRIAL APPLICABILITY

-

### Sequence Listing Free Text

-

What is claimed is:

1. An electronic apparatus comprising:
a memory; and
a processor configured to quantize a neural network, trained based on deep learning, to generate a quantized neural network, and store the quantized neural network in the memory,
wherein the processor is configured to:
quantize, in a preset first bit unit, trained connection strengths between neurons of the trained neural network, dequantize the quantized connection strengths in a preset second bit unit, retrain the dequantized connection strengths, and quantize the retrained connection strengths in the preset first bit unit.

2. The electronic apparatus of claim 1, wherein the processor is configured to after the quantization, iteratively perform dequantization, retraining, and quantization in preset time units.

3. The electronic apparatus of claim 2, wherein the processor is configured to:
calculate an accuracy of the trained connection strength,
calculate an accuracy of quantizing the retrained connection strength in the preset first bit units, and
based on the accuracy of quantization being within a preset range from the accuracy of the trained connection strength, stop the iterative operation.

4. The electronic apparatus of claim 1, wherein the processor is configured to:
calculate an accuracy of the trained connection strength, and
in performing the retraining, perform the retraining until the accuracy of the retrained connection strength belongs to a preset range from the accuracy of the trained connection strength.

5. The electronic apparatus of claim 1, wherein the preset first bit unit is one bit, and the preset second bit unit is 32 bits.

6. The electronic apparatus of claim 1, wherein the processor is configured to perform the quantization using Equation 1 below and perform the dequantization using Equation 2 below:
$${min}_{{\{ {a}_{i} , {b}_{i} \}}_{i = 1}^{k}} {‖ w - {\sum }_{i = 1}^{k} {a}_{i} {b}_{i} ‖}^{2} \qquad [ Equation 1 ]$$
(w=connection strength, a=optimal coefficient, b=(−1 or +1), k>1)
$${\sum }_{i = 1}^{k} {a}_{i} {b}_{i} \qquad [ Equation 2 ]$$
(a=optimal coefficient, b=(−1 or +1))

7. The electronic apparatus of claim 1, further comprising:
a communicator,
wherein the processor is configured to control the communicator to transmit, to an external device, a neural network in which the retrained connection strength is quantized in the preset first bit unit.

8. A method for controlling an electronic apparatus for quantizing a neural network, trained based on deep learning, to generate a quantized neural network, and store the quantized neural network, the method comprising:
quantizing, in a preset first bit unit, trained connection strengths between neurons of the trained neural network;
dequantizing the quantized connection strengths in a preset second bit unit;
retraining the dequantized connection strengths; and
quantizing the retrained connection strengths in the preset first bit units.

9. The method of claim 8, wherein further comprising after the quantization: dequantization, retraining, and quantization are iteratively performed in preset time units.

10. The method of claim 9, further comprising:
calculating an accuracy of the trained connection strength; and
calculating an accuracy of quantizing the retrained connection strength in the preset first bit units,
wherein the iteratively performing comprises, based on the accuracy of quantization being within a preset range from the accuracy of the trained connection strength, stopping the iterative operation.

11. The method of claim 8, further comprising:
calculating an accuracy of the trained connection strength,
wherein the performing the retraining comprises performing the retraining until the accuracy of the retrained connection strength belongs to a preset range from the accuracy of the trained connection strength.

12. The method of claim 8, wherein the preset first bit unit is one bit, and the preset second bit unit is 32 bits.

13. The method of claim 8, wherein the quantizing is performed using Equation 1 below and the dequantizing is performed using Equation 2 below:
(w=connection strength,a=optimal coefficient,b=(−1 or +1),k>1) [Equation 1]
$${\sum }_{i = 1}^{k} {a}_{i} {b}_{i} \qquad [ Equation 2 ]$$
(a=optimal coefficient, b=(−1 or +1))

14. The method of claim 8, further comprising:
transmitting, to an external device, a neural network in which the retrained connection strength is quantized in the preset first bit unit.
